(19) United States
(12) Patent Application Publication
(10) Pub. No.: US 2008/0085367 A1
(43) Pub. Date: Apr. 10, 2008

(54) Method and Apparatus for Producing Transfer Belt for Image Forming Apparatus and Transfer Belt for Image Forming Apparatus

(76) Inventors: Kazuaki Ikeda, Osaka (JP); Hiroshi Okazaki, Osaka (JP); Masahiro Habuka, Osaka (JP)

Correspondence Address: MCDERMOTT WILL & EMERY LLP, 600 13TH STREET, N.W., WASHINGTON, DC, 20005-3096, US

(21) Appl. No.: 11/659,239

(22) PCT Filed: Aug. 3, 2005
(86) PCT No.: PCT/JP05/14204

§ 371 Date: Aug. 29, 2007

(30) Foreign Application Priority Data
Aug. 4, 2004 (JP) 2004-228275

(51) Int. Cl. B05D 3/12

(52) U.S. Cl. 427/296; 118/50

(57) ABSTRACT

The invention provides a producing method for a transfer belt for image forming apparatus of forming a binder layer for example of THV on a surface layer of PTFE or PFA to form a first composite member, forming an elastic layer for example of urethane on a base layer of PI, PAI or PVDF to form a second composite member, and then heating fusing the first composite member and the second composite member, a transfer belt for image forming apparatus produced by the producing method, and a producing apparatus for a transfer belt for image forming apparatus to be used in the producing method.

### TECHNICAL FIELD

The present invention relates to a producing method and a producing apparatus for a transfer belt for an image forming apparatus, and to a transfer belt for an image forming apparatus, and more particularly to a producing method and a producing apparatus for a transfer belt to be used, in a color image forming apparatus utilizing an electrophotographic process such as a color copying machine or a color laser printer, for transferring a toner image from a photosensitive drum onto a transfer material (paper), and a transfer belt for an image forming apparatus produced by such producing method or producing apparatus.

### RELATED ART

As an image transfer process in a color image forming apparatus such as a color copying machine or a color laser printer, a process of transferring a toner image, formed on a photosensitive drum, onto a transfer material (paper) by means of a transfer belt for image forming apparatus is becoming utilized as a standard process.

FIG. 8 is a schematic view showing an outline of an intermediate transfer process, which is one of such transfer process. As shown in FIG. 8, a toner image is formed on a photosensitive drum 3, by a toner 1 and a developing roller 2. As this is a 4-drum tandem system, a developing roller and a photosensitive drum are provided corresponding to each of toners of four colors. The toner image, formed on the photosensitive drum 3, is transferred onto a transfer belt 5 for image forming apparatus, by the cooperation of a primary transfer roller 4, the photosensitive drum 3 and the transfer belt 5 for image forming apparatus. A color image, thus formed, is transferred onto a transfer material (paper) 7 by the cooperation of a secondary transfer roller 6, the transfer belt 5 for image forming apparatus and the transfer material (paper) 7, and is fixed by a fixing roller (not shown). The basic principle is similar also in a multiple transfer process.

The transfer belt for image forming apparatus, to be employed in these processes, is desired to have a large resistivity (surface resistivity) in the circumferential direction of the belt, and a resistivity in a thickness direction (volume resistivity) smaller than the surface resistivity, and it is further desired to have properties that such resistivities do not change by a position on the belt, an environment of use or a voltage, that the belt has a high tensile modulus in the circumferential direction, that the belt surface is smooth and has a large contact angle whereby the toner can be easily transferred to the transfer material (paper) from the belt (satisfactory toner releasing property), that it does not chemically contaminate the photosensitive drum or the toner (satisfactory non-contaminating property), and that it is flame retardant.

As it is difficult to satisfy these many properties by a single-layered transfer belt for image forming apparatus, there are proposed multi-layered transfer belts for image forming apparatus, and, for example, JP-A-2002-287531 discloses a transfer belt for image forming apparatus, formed by a base layer of a thermoplastic elastomer of a low resistance and a surface layer of a thermoplastic elastomer of a high resistance, wherein the base layer and the surface layer are formed by heat molding.

Further, there is recently desired a transfer belt for image forming apparatus, having elasticity in the thickness direction, and, as a transfer belt for image forming apparatus having such property, there can be conceived a belt having an elastic layer, formed by an elastic member, in addition to the base layer and the surface layer.

In such multi-layered transfer belt for image forming apparatus, the high tensile modulus in the circumferential direction of the belt is achieved by the base layer, while the elasticity in the thickness direction is achieved by the elastic layer. On the other hand, the volume resistivity is stably controlled for example by selecting the materials constituting the base layer and the elastic layer. Also the high surface resistivity, the satisfactory toner releasing property and the satisfactory non-contaminating property are desirably achieved by the surface layer.

However, a transfer belt for image forming apparatus, sufficiently satisfying these properties, has not been obtained in the prior technology.

As the transfer belt for image forming apparatus capable of meeting these requirements, the present inventors have found a following transfer belt for image forming apparatus.

More specifically, the present inventors have found a transfer belt for image forming apparatus, which includes a base layer, an elastic layer provided on the base layer and formed by an elastomer such as urethane, and a surface layer provided on the elastic layer and formed by a fluorine-containing polymer.

The aforementioned transfer belt for image forming apparatus can achieve a high surface resistivity, an excellent toner releasing property and an excellent non-contaminating property because of use of the surface layer formed by the fluorine-containing polymer, and also has a sufficient flexibility in the thickness direction because the elastic layer, formed by an elastomer such as urethane, is provided between the base layer and the surface layer, thereby capable of carrying the toner without crushing and attaining a higher image quality.

In the aforementioned invention, however, the adhesion between the fluorine-containing polymer constituting the surface layer and the elastomer such as urethane constituting the elastic layer is achieved generally by a physical treatment such as a plasma treatment or a blasting, or by a primer, and the former requires excessive work and time thus leading to an elevated cost, while the latter leads to a possibility of a bleeding out of a contaminating substance through the thin surface layer.

Further, it may be conceivable to coat a substance, constituting the surface layer, on the urethane or the like constituting the elastic layer by a spraying method or a dipping method, followed by a sintering, but the surface layer cannot be sintered because the urethane or the like in the elastic layer has a thermal decomposition temperature lower than the sintering temperature of the surface layer.

Further, it is conceivable to fit the surface layer of an extruded tubular shape on a member formed by a base layer and an elastic layer, but this method can only produce a transfer belt for image forming apparatus of a small diameter (less than φ100 mm) and is difficult to obtain a surface layer of a small thickness less than 30 μm.

In addition to such detriments, the transfer belt for image forming apparatus has to be formed in an endless shape.

Patent Reference 1: JP-A-2002-287531 (Claim 1)

### DISCLOSURE OF THE INVENTION

### Problems to be Solve by the Invention

With respect to the transfer belt for image forming apparatus including a base layer, an elastic layer provided on the base layer, and a surface layer provided on the elastic layer and formed by a fluorine-containing polymer, it has been desired to develop a method and an apparatus capable of producing a transfer belt for image forming apparatus which has a larger surface resistivity, an excellent toner releasing property, an excellent non-contaminating property and a stable volume resistivity, which is free from the possibility of bleeding out of the contaminating substance and in which an excellent adhesive power is secured between the surface layer and the elastic layer, without requiring excessive work and time and without fusion or thermal deformation of the elastic layer, and to develop a transfer belt for image forming apparatus produced by such producing method or apparatus.

Further, in order to respond to the ever increasing demand of the users for reliability and durability, it has been desired to develop a technology for adhering the elastic layer and the surface layer, formed by the fluorine-containing polymer, more securely and efficiently than in the prior technologies.

Still further, it has been desired to develop a producing method and a producing apparatus capable of executing such adhesion.

### Means for Solving the Problems

As a result of intensive investigations, it is found by the present inventors that the aforementioned objects can be accomplished by selecting optimum materials for the layers of a transfer belt for image forming apparatus, providing a specified binder layer between the surface layer and the elastic layer, separately producing a composite member constituted of the surface layer and the binder layer and a composite member constituted of the base layer and the elastic layer, and then uniting the both composite members, and also by forming the composite member constituted of the surface layer and the binder layer on an internal surface of an external tube, in order to obtain an endless shape.

Further, it is found that the adhesive property can be improved by blending a substance, in the binder layer, common to that in the surface layer.

Still further, developed is a method of securely and efficiently adhering a first composite member, constituted of the surface layer and the binder layer, and a second composite member, constituted of the base layer and the elastic layer, produced separately, and an apparatus for executing such method.

According to claim 1 of the present invention, there is provided:

a producing method for a transfer belt for image forming apparatus, including:

a first composite member forming step of forming a surface layer formed by polytetrafluoroethylene (PTFE) or tetrafluoroethylene perfluoroalkylvinyl ether (PFA), and then forming a binder layer on the surface layer to form a first composite member;

a second composite member forming step of forming an elastic layer constituted of an elastomer on a base layer constituted of at least a material selected from a class of polyimide (PI), polyamidimide (PAI) and polyvinylidene fluoride (PVDF) to form a second composite member; and

a composite member fusing step of heat fusing the binder layer of the first composite member and the elastic layer of the second composite member, wherein

the binder layer is formed by a material of which a melting point is equal to or lower than a thermal decomposition point of a material constituting the elastic layer, and of which a thermal decomposition point is equal to or higher than a melting point of a material constituting the surface layer.

In the present invention, in the surface layer of the transfer belt for image forming apparatus, employed is polytetrafluoroethylene (PTFE) or tetrafluoroethylene perfluoroalkylvinyl ether (PFA), which is excellent in the surface resistivity and the non-contaminating property and has a high (large) contact angle thereby enabling clear release of the toner, among the fluorine-containing polymers.

Further, as the elastic layer, an elastomer rich in elasticity is employed.

Further, as the base layer, polyimide (PI), polyamidimide (PAI) or polyvinylidene fluoride (PVDF), which is particularly excellent in the tensile modulus as the transfer belt for image forming apparatus and in the adhesive property to the elastic layer, is employed.

In the present invention, the transfer belt for image forming apparatus, having such excellent layers, is produced, as described above, by forming a first composite member constituted of the surface layer and the aforementioned specified binder layer, separately forming a second composite member constituted of the base layer and the elastic layer, and heat fusing the binder layer and the elastic layer.

In order to enable the producing method above, the binder layer of the present invention employs a material of which a melting point is equal to or lower than a thermal decomposition point of the material constituting the elastic layer and of which a thermal decomposition point is equal to or higher than a melting point of the material constituting the surface layer.

Thus, since the binder layer has a melting point equal to or lower than the thermal decomposition point of the material constituting the elastic layer, the binder layer and the elastic layer can be adhered firmly by pressing the binder layer and the elastic layer with each other under heating at a temperature equal to or higher than the melting points of the binder layer and the elastic layer and equal to or lower than the thermal decomposition points of the binder layer and the elastic layer.

Further, since the binder layer is constituted of the material of which a thermal decomposition point is equal to or higher than a melting point of the material constituting the surface layer, both layers can be melt fused by heating at a temperature equal to or higher than the melting point of the surface layer and equal to or lower than the thermal decomposition point of the surface layer.

Therefore, the binder layer can be formed without excessive work and time, and does not contain a substance contaminating the surface layer such as a primer, thus avoiding the possibility of bleeding out of the contaminating substance through the thin surface layer.

Further, even if the elastic layer contains a defect, such defect can be erased as the elastic layer is fused at the thermal adhesion thereof with the binder layer.

Further, the transfer belt for image forming apparatus may be produced with a large diameter (+100 mm or larger). Still further, a thin surface layer may be easily obtained, for example with a thickness less than 30 μm, particularly of about 1 μm, while a thick surface layer can also be provided.

As described above, according to the present invention, in the transfer belt for image forming apparatus formed by combining specified excellent layers, there is provided a producing method capable of accomplishing the aforementioned objects while adding a layer of a specified material.

The producing method of the present invention is not limited to the aforementioned structure in which each layer is directly provided on another layer, but an adhesive layer or another layer may be provided between the aforementioned layers as long as the objects of the present invention are not hindered.

In the transfer belt for image forming apparatus, in order to improve the toner releasing property, it is preferable to reduce the roughness of the external tube.

In the present invention, this requirement can be easily met by mirror finishing the internal surface of the external tube.

Claim 2 of the present invention corresponds to such a preferred embodiment, and there is provided:

a producing method for a transfer belt for image forming apparatus, wherein

the internal surface of the external tube is mirror finished.

As the first composite member is formed on the internal surface of the external tube, the second composite member has to be provided inside the external tube. Such second composite member can be efficiently produced by a process of forming the base laser on a cylindrical mold, then forming the elastic layer on the base layer, and separating the second composite member, constituted of the base layer and the elastic layer, from the cylindrical mold.

Claim 3 of the present invention corresponds to such a preferred embodiment, and there is provided:

a producing method for a transfer belt for image forming apparatus, wherein

the step of forming the second composite member includes:

a step of forming the base layer on a cylindrical mold;

a step of forming the elastic layer on the base layer; and

a step of separating a composite member constituted of the base layer and the elastic layer from the cylindrical mold to form a cylindrical second composite member.

After the formation of the first composite member constituted of the surface layer and the binder layer on the internal surface of the external tube, it is necessary to unite such first composite member with the cylindrical second composite member, separately formed and constituted of the base layer and the elastic layer, by heat fusing the binder layer of the first composite member and the elastic layer of the second composite member.

For such fusion, a method of inserting the cylindrical second composite member into the inside of the external tube and then inflating the second composite member under heating, to pressurize the same to the first composite member formed on the internal surface of the external tube, is efficient and preferable.

For such method, a method utilizing an explosive power for example of a gunpowder is conceivable, but a method of utilizing a difference in the thermal expansion coefficient is preferable, since it is usable also as heating means.

More specifically, there is an efficient method of inserting an internal core, having a thermal expansion coefficient larger than a thermal expansion coefficient of the external tube, inside the cylindrical second composite member, then inserting the internal core into the external tube and heating the external tube and the internal core, to heat fuse the two composite members.

Claim 4 of the present invention corresponds to such preferred embodiment, and there is provided:

a producing method for a transfer belt for image forming apparatus, wherein

the composite member fusing step includes:

a first internal core insertion step of inserting an internal core, having a thermal expansion coefficient larger than a thermal expansion coefficient of the external tube, into the interior of the cylindrically formed second composite member;

a second internal core insertion step of inserting the internal core, inserted inside the second composite member, into the external tube; and

a composite member heat fusing step of heating the external tube and the internal core to heat fuse the binder layer of the first composite member and the elastic layer of the second composite member.

The internal core is preferably formed of a material having a large thermal expansion coefficient, particularly of MC nylon or a fluorinated resin.

Claim 5 of the present invention corresponds to such preferred embodiment, and there is provided:

a producing method for a transfer belt for image forming apparatus, wherein

the internal core is formed by MC nylon or a fluorinated resin.

For another preferable method, there is a method utilizing a fluid pressure. As this method is executed in a vacuum environment in addition to heating, a secure adhesion can be achieved without gas remaining on the adhered surface.

Claim 6 of the present invention corresponds to such a preferred producing method, and there is provided:

a producing method for a transfer belt for image forming apparatus, wherein

the composite member fusing step includes:

a water bag insertion step of fitting the second composite member on an external periphery of a water bag closed on both ends and having a hollow cylindrical shape, of which a radius is capable to be increased or decreased by regulating a pressure of a fluid filled therein, and inserting the water bag in such a state inside the first composite member fixed on the internal surface of the external tube;

an evacuating step, after the water bag insertion step, of maintaining the exterior of the water bag in vacuum state;

a pressurizing step, after the water bag insertion step, of increasing a pressure of the fluid filled in the water bag to increase a diameter of the water bag to cause the external periphery of the second composite member, present on the external periphery of the water bag, to pressurize onto an internal periphery of the first composite member; and

an adhesion step, after the evacuating step and the pressurizing step, of heating the interior of the vacuum chamber to adhere the external periphery of the second composite member and the internal periphery of the first composite member.

In this producing method, the second composite member including the base layer and the elastic layer, in a state fitted on the water bag closed on both ends and having a hollow cylindrical shape, is inserted into the first composite member fixed on the internal surface of the external tube, then the pressure of the fluid filled in the water bag is elevated by a pressure regulating pump to increase the diameter of the water bag together with the second composite member, thereby pressurizing the external surface thereof to the internal surface of the first composite member, and an evacuation is executed in this state and a heating is executed inclusive of the vacuum chamber, to adhere the first composite member and the second composite member. After the adhesion of both composite members, the pressure is reduced to the original atmospheric pressure, then the temperature is lowered and the pressure of the fluid filled in the water bag is reduced to the decrease the diameter of the water bag, whereupon the water bag is extracted from a resinous belt formed by the firm adhesion of the first composite member and the second composite member.

Finally, the resinous belt is separated from the internal surface of the external tube.

The water bag is not restricted in the material thereof, as long as the diameter is regulable by the internal fluid.

The fluid is not limited to water but includes a gas, silicone oil or the like. Particularly in case of heating at a temperature of 150° C. or higher at the adhesion, an oil with a low vapor pressure is preferable to water.

Further, the pressure regulating pump is not limited to a pump as long as the pressure in the water bag can be controlled and regulated.

The vacuum used at the adhesion is to prevent a void generation caused by a gas remaining on the adhered surface.

Further, the adhesion of the internal surface of the first composite member and the external surface of the second composite member is executed in a state where the first composite member is fixed at the external surface to the external tube formed by a metal cylinder and in a state where the second composite member is pressurized radially outwards from the inside, whereby both composite members are adhered securely with a satisfactory dimensional precision.

Further, the adhesion, being executed in vacuum, does not involve detriments such as gas remaining on the adhered surface, and satisfactory adhesion and dimension can be secured also in this respect.

Furthermore, the water bag which pressurizes the first composite member from the inside in radially outward direction at the adhesion, is extendable or shrinkable in the external diameter by a control of the pressure of the internal fluid, thereby facilitating the insertion into the first composite member prior to the adhesion and the detachment of the belt, formed by adhering both composite members after the adhesion.

The water bag, preferably prepared with silicone rubber in at least a cylindrical part serving for pressurization at the adhesion of resin layers, does not lose the flexibility to a high temperature of about from 200 to 250° C. and shows an excellent releasing property from the resin, thus capable of facilitating, after the adhering process, the operation of extracting the water bag from the resinous belt formed by adhering the first composite member and the second composite member.

Claim 7 of the present invention corresponds to such a preferable embodiment, and there is provided:

a producing method for a transfer belt for image forming apparatus, wherein

the water bag utilizes silicone rubber in an external peripheral surface thereof.

A material constituting the binder layer is preferably soluble in a solvent. Thus, the adhesion can be achieved merely by dissolving the material, constituting the binder layer, in a solvent and coating the material on the surface layer by a spraying method or a dipping method.

Claim 8 of the present invention corresponds to such a preferable embodiment, and there is provided:

a producing method for a transfer belt for image forming apparatus, wherein

the material constituting the binder layer is a material soluble in a solvent.

The binder layer is preferably constituted of a fluorine-containing polymer, and particularly preferably of a copolymer (THV) of tetrafluoroethylene, hexafluoropropylene and vinylidene fluoride, because it is easily adherable with PTFE or PFA owing to presence of a tetrafluoro component, is available in a grade having a melting point as low as 110° C., has a decomposition point as high as 400° C. (equal to or higher than the melting point of PTFE), has an excellent adherability with urethane or the like, and is flexible.

Particularly preferable is a case where the binder layer is formed by THV, the surface layer is formed by PTFE and the elastic layer is formed by urethane.

Claim 9 of the present invention corresponds to such a preferable embodiment, and there is provided:

a producing method for a transfer belt for image forming apparatus, wherein

the binder layer is constituted of a copolymer (THV) of tetrafluoroethylene, hexafluoropropylene and vinylidene fluoride.

As described above, the fluorine-containing polymer, employed as the surface layer of the transfer belt for image forming apparatus has an excellent toner releasing property. In the case of utilizing such fluorine-containing polymer in the surface layer, the binder layer may also be formed by a fluorine-containing polymer to achieve a sufficiently firm adhesion of both layers. The adhesive power of both layers can be further increased by adding a fluorine-containing polymer, same as that constituting the surface layer, in the polymer of the binder layer. Such method allows to achieve adhesion with the surface layer, even when the binder layer is not formed by the fluorine-containing polymer.

The fluorine-containing polymer to be contained in the binder layer is preferably contained, in a state of a powdered substance, in the material constituting the binder layer. In such case, the powdered substance preferably has a particle size within a range of from 0.01 to 10 μm. This is because a powdered substance of a particle size less than 0.01 μm is difficult to manufacture, while a particle size exceeding 10 μm is liable to cause a deposition and to deteriorate the surface roughness.

The fluorine-containing polymer to be contained in the binder layer, when used in an excessively small amount, cannot provide a sufficient effect of improving the adhesive power, and, when used in an excessively large amount, causes a large influence on the characteristics of THV or the like, principally constituting the binder layer. In consideration of such situation, the preferable amount of the fluorine-containing polymer to be contained in the binder layer is from 1 to 300 parts with respect to 100 parts of the material constituting the binder layer. Particularly in the case that the surface layer is constituted of PFA and the binder layer is constituted of THV, PFA is preferably contained in an amount of from 10 to 100 parts in THV.

Claim 10 of the present invention corresponds to such a preferable embodiment, and there is provided:

a producing method for a transfer belt for image forming apparatus, wherein

the binder layer contains a fluorine-containing polymer which constitutes the surface layer.

Examples of the elastomer of the elastic layer include urethane, acrylonitrile-butadiene rubber, ethylene rubber, silicone rubber and polyamide, among which urethane is most preferable.

Also as the elastomer, an elastomer rendered ionic conductive is preferably used in view of stabilizing the volume resistivity.

Claim 11 of the present invention corresponds to such a preferable embodiment, and there is provided:

a producing method for a transfer belt for image forming apparatus, wherein

the elastomer is urethane.

The transfer belt for image forming apparatus obtained by the above-described producing method is a transfer belt for image forming apparatus that has a larger surface resistivity, an excellent toner releasing property, and a stabler volume resistivity, and that is free from possibility of causing a bleeding of contaminating substances and has a secure adhesive power between the surface layer and the elastic layer, thus capable of attaining a high image quality.

Claim 12 of the present invention corresponds to such a preferable embodiment, and there is provided:

a transfer belt for image forming apparatus produced by the producing methods described above.

Such transfer belt for image forming apparatus preferably has a thickness of from 1 to 15 μm in the surface layer, from 0.1 to 10 μm in the binder layer, from 50 to 300 μm in the elastic layer, and from 30 to 100 μm in the base layer.

The transfer belt for image forming apparatus as described in any of claims 1 to 3 and claims 6 to 11 is preferably produced by an apparatus, which realizes the invention of claim 6 for producing method as an apparatus and which includes a water bag for pressurizing the adhesion surface of the first composite member and the second transfer belt for image forming apparatus, a pressure regulating pump therefor, a vacuum chamber for accommodating the water bag at the pressurization, and a heater for heating the interior of the vacuum chamber.

Claim 13 of the present invention corresponds to such a preferable embodiment, and there is provided:

a producing apparatus for use in the producing method for the transfer belt for image forming apparatus according to any one of claims 1 to 3 and claims 6 to 11, including:

a water bag having a hollow cylindrical shape, which is capable to be inserted, in a state where the second composite member is fitted on an external periphery thereof, inside the first composite member fixed on the internal surface of the external tube, and of which a radius is capable to be increased or decreased by regulating a pressure of a fluid filled therein;

a pressure regulating pump for regulating the pressure of the fluid filled in the water bag;

a vacuum chamber in which the water bag is capable to be provided in a state communicating with the pressure regulating pump; and

a heater for heating the interior of the vacuum chamber.

Also in this invention for the producing apparatus, the water bag is preferably constituted of silicone rubber as in the invention of claim 7.

Claim 14 of the present invention corresponds to such a preferable embodiment, and there is provided:

a producing apparatus for a transfer belt for image forming apparatus, wherein

the water bag utilizes silicone rubber in an external peripheral surface thereof.

The transfer belt for image forming apparatus of the present invention includes a transfer belt for image forming apparatus for executing a transfer and a fixation simultaneously, and, in view of the efficiency, it is preferable to apply the present invention to such transfer belt for image forming apparatus.

### EFFECT OF THE INVENTION

The present invention allows to produce a transfer belt for image forming apparatus that has a larger surface resistivity, an excellent toner releasing property, and a stabler volume resistivity, and that is free from possibility of causing a bleeding of contaminating substances and has a secure adhesive power between the surface layer and the elastic layer, without requiring excessive work and time, and without fusion or thermal deformation of the elastic layer.

### BRIEF DESCRIPTION OF THE DRAWINGS

[FIG. 1]

FIG. 1 is a view conceptually showing a state where a first composite member is formed on an internal surface of an external tube.

[FIG. 2]

FIG. 2 is a view conceptually showing a state where a second composite member is formed on an external surface of a drum-shaped mold.

[FIG. 3]

FIG. 3 is a view conceptually showing a state where an internal core is fitted inside the second composite member.

[FIG. 4]

FIG. 4 is a view conceptually showing a state where the internal core, in a state fitted in the second composite member, is inserted into the first composite member on the internal surface of the external tube.

[FIG. 5]

FIG. 5 is a cross-sectional view showing an embodiment of the transfer belt for image forming apparatus of the present invention.

[FIG. 6]

FIG. 6 is a view conceptually showing the structure of an apparatus for executing adhesion of the first composite member and the second composite member, utilizing a water bag.

[FIG. 7]

FIG. 7 is a view conceptually showing a state of executing adhesion by the apparatus above.

[FIG. 8]

FIG. 8 is a schematic view showing an image transfer process utilizing the transfer belt for image forming apparatus.

### DESCRIPTION OF SYMBOLS

1 toner
2 developing roller
3 photosensitive drum
4 primary transfer roller
5 transfer belt for image forming apparatus
6 secondary transfer roller
7 transfer material
8 external tube
9 surface layer
10 drum-shaped mold
11 base layer
12 elastic layer
13 internal core
14 binder layer
50 water bag
51 trunk part
52 inflated trunk part
   55 end plate
   59 pump
   60 vacuum chamber
   61 cover
   62 vacuum pump
   70 heater

### BEST MODE FOR CARRYING OUT THE INVENTION

Now the present invention will be explained by a best embodiment thereof. However, the present invention is not limited to the following embodiment, which is subject to various modifications within the range identical or equivalent to the present invention.

### First Embodiment

This embodiment is to insert the second composite member layer, prepared by forming the elastic member layer on the external surface of the base layer, into the internal side of the first composite member, prepared by forming the binder layer on the internal side of the surface layer, and to utilize the internal core for adhering both layers.

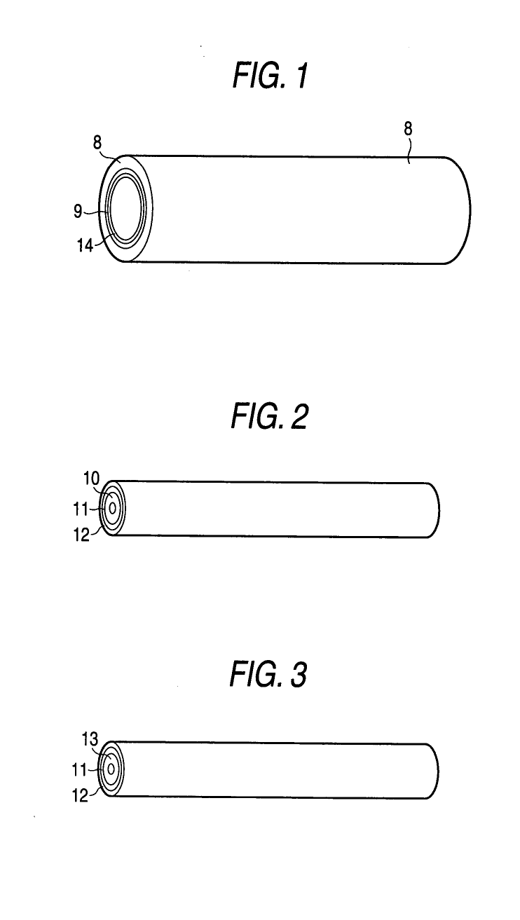

At first, as shown in FIG. 1, on an internal surface of a steel external tube 8 having a thermal expansion coefficient of 1.76×10⁻⁵/° C. and having a mirror-finished internal surface, PTFE (melting point: 327° C., thermal decomposition point: 400° C.) is coated by a dipping method, and sintered at 380° C. to obtain a surface layer 9.

Then, THV polymer (melting point: 120° C., thermal decomposition point: 400° C.) is dissolved in butyl acetate, and formed into a film by a dipping method on the surface layer 9, and dried to obtain a binder layer 14. Then the binder layer 14 is heated at 350° C., higher than the melting points of PTFE and THV, thereby being adhered to the surface layer 9.

Then, polyimide, subjected to a conductive carbon treatment for adjusting the volume resistivity, is formed into a film on the surface of the drum-shaped mold 10 as shown in FIG. 2, and sintered at 380° C. to obtain a base layer 11.

Then, on the base layer 11, aqueous urethane rendered ionic conductive (melting point: 120° C., thermal decomposition point: 180° C.) is coated by a dipping method and dried to obtain an elastic layer 12.

The ionic conductive treatment is executed by dispersing an ionic conductive agent in the aqueous urethane.

Then, a composite member of the base layer 11 and the elastic layer 12, formed on the surface of the drum-shaped mold 10, is peeled off from the drum-shaped mold 10, and the composite member formed in a cylindrical shape is fitted, as shown in FIG. 3, on the external periphery of an internal core 13 of MC nylon, having a thermal expansion coefficient of 8.0×10⁻⁵/° C.

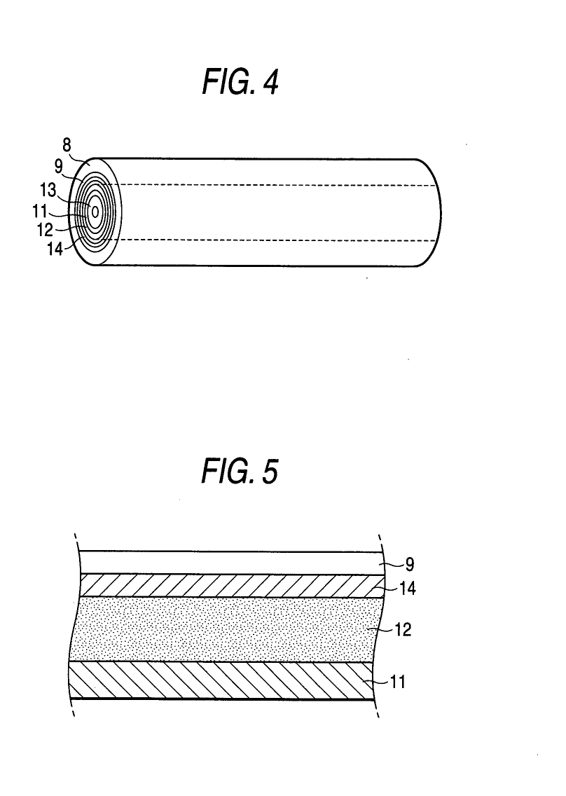

Then, as shown in FIG. 4, the internal core 13, on which the composite member of the base layer 11 and the elastic layer 12 is fitted, is inserted into the external tube 8 provided, on the internal surface thereof, with the composite layer of the binder layer 14 and the surface layer 9, and is heated to 150° C. in vacuum. Under such heating, as the external tube 8 and the internal core 13 have a difference in the thermal expansion coefficient, the thermally expanded internal core 13 pressurizes the internal surface of the external tube 8, whereby obtained is a composite member of 4-layered structure shown in FIG. 5, formed by the composite layer of the base layer 11 and the elastic layer 12, and the composite layer of the binder layer 14 and the surface layer 9.

Then, the internal core 13 and the external tube 8 are cooled, and the composite member of 4-layered structure is separated therefrom to obtain a transfer belt for image forming apparatus.

The transfer belt for image forming apparatus thus obtained included, on the base layer (polyimide) of a thickness of 65 μm, an elastic layer (urethane rendered ionic conductive) of a thickness of 200 μm, a binder layer (THV) of a thickness of 3 μm, and a surface layer (PTFE) of a thickness of 7 μm, and there could be obtained a transfer belt for image forming apparatus excellent in the surface resistivity, the toner releasing property and the non-contaminating property.

Firm adhesion is attained between the surface layer and the binder layer and between the binder layer and the elastic layer, and no bleeding is observed.

As the THV polymer in the binder layer has a thermal decomposition point of 120° C. while the PTFE in the surface layer has a melting point of 327° C., it is difficult to sinter the surface layer in a process of forming the elastic layer, the binder layer and the surface layer in succession on the base layer for example by a spraying method, but the above-described producing method enabled secure sintering of the surface layer.

### Second Embodiment

The present embodiment relates to a binder layer containing a fluorine-containing polymer which constitutes the surface layer.

As shown in FIG. 1, on an internal surface of a steel external tube 8 having a thermal expansion coefficient of 1.76×10⁻⁵/° C. and having a mirror-finished internal surface, PFA (350J dispersion, particle size 0.2 μm, manufactured by du Pont de Nemours & Co.) (melting point 295° C.) is coated by a dipping method and sintered at 380° C. to obtain a surface layer 9.

Then, THV polymer (THV220, manufactured by Sumitomo 3M Co.) (melting point: 120° C., thermal decomposition point: 400° C.) is dissolved in butyl acetate, and formed into a film by a dipping method on the surface layer 9, and dried to obtain a binder layer 14. Then the binder layer 14 is heated at 350° C., higher than the melting points of PFA and THV, thereby being adhered to the surface layer 9. Process is executed in otherwise same manner as in the first embodiment to obtain a transfer belt for image forming apparatus.

The transfer belt for image forming apparatus thus obtained included, on the base layer (polyimide) of a thickness of 60 μm, an elastic layer (urethane rendered ionic conductive) of a thickness of 200 μm, a binder layer (THV) of a thickness of 3 μm, and a surface layer (PFA) of a thickness of 5 μm, and there could be obtained a transfer belt for image forming apparatus excellent in the surface resistivity, the toner releasing property and the non-contaminating property.

In the transfer belt for image forming apparatus, the volume resistivity is stably controlled by the elastic layer 12.

Firm adhesion is attained between the surface layer and the binder layer and between the binder layer and the elastic layer, and no bleeding is observed.

As the THV polymer in the binder layer has a thermal decomposition point of 120° C. while the PFA in the surface layer has a melting point of 295° C., it is difficult to sinter the surface layer in a process of forming the elastic layer, the binder layer and the surface layer in succession on the base layer for example by a spraying method, but the above-described producing method realized a firm adhesion between the elastic layer and the binder layer.

### Third Embodiment

The present embodiment also relates to a binder layer containing a fluorine-containing polymer which constitutes the surface layer.

For forming the binder layer, powdered PFA (340J, particle size 0.2 μm, manufactured by du Pont de Nemours & Co.), used for forming the surface layer, is in advance added to the THV polymer (THV220, manufactured by Sumitomo 3M Co.) in an amount of 60 parts with respect to 100 parts of THV polymer, and the THV polymer is dissolved in butyl acetate. Process is otherwise executed in the same manner as in the second embodiment to obtain a transfer belt for image forming apparatus.

The transfer belt for image forming apparatus thus obtained included, on the base layer (polyimide) of a thickness of 60 μm, an elastic layer (urethane rendered ionic conductive) of a thickness of 200 μm, a binder layer (THV) of a thickness of 3 μm, and a surface layer (PFA) of a thickness of 5 μm, and there could be obtained a transfer belt for image forming apparatus excellent in the surface resistivity, the toner releasing property and the non-contaminating property.

Then, on the transfer belts for image forming apparatus obtained in the first to third embodiments, an adhesive power between the surface layer and the binder layer is measured. The measurement is conducted in the following manner.

In a measuring position prepared by forming a notch of a width of 1 cm in the surface layer and the binder layer, a force required for peeling off both layers is measured as an adhesive power.

As a result of measurement, the first embodiment and the second embodiment provided an adhesive power of 0.06 kg/cm, while the third embodiment provided an adhesive power of 0.35 kg/cm. Based on these results, it is confirmed that the adhesive power between the surface layer and the binder layer could be improved when the binder layer contained the fluorine-containing polymer constituting the surface layer.

### Fourth Embodiment

The present embodiment utilizes a water bag in the adhesion of the first composite member and the second composite member.

At first the apparatus will be explained.

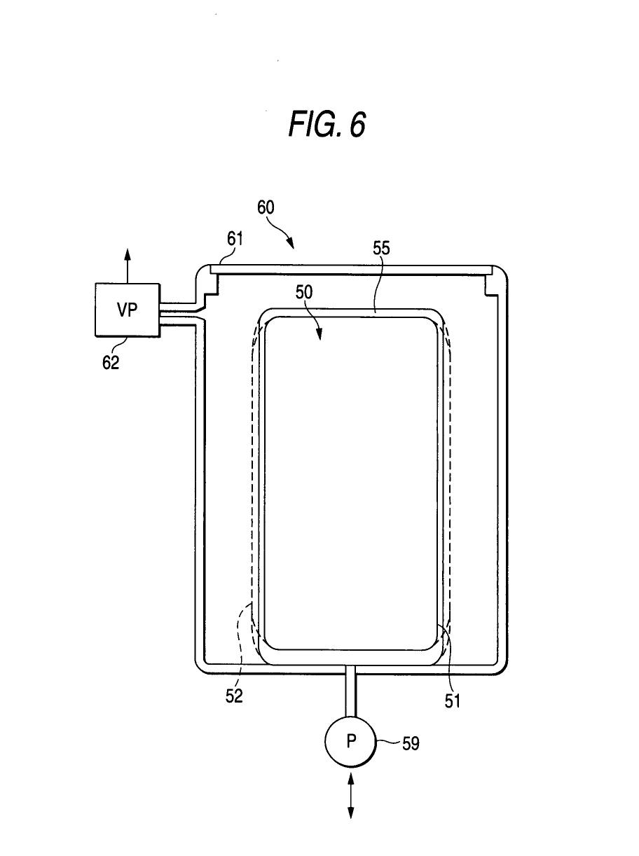

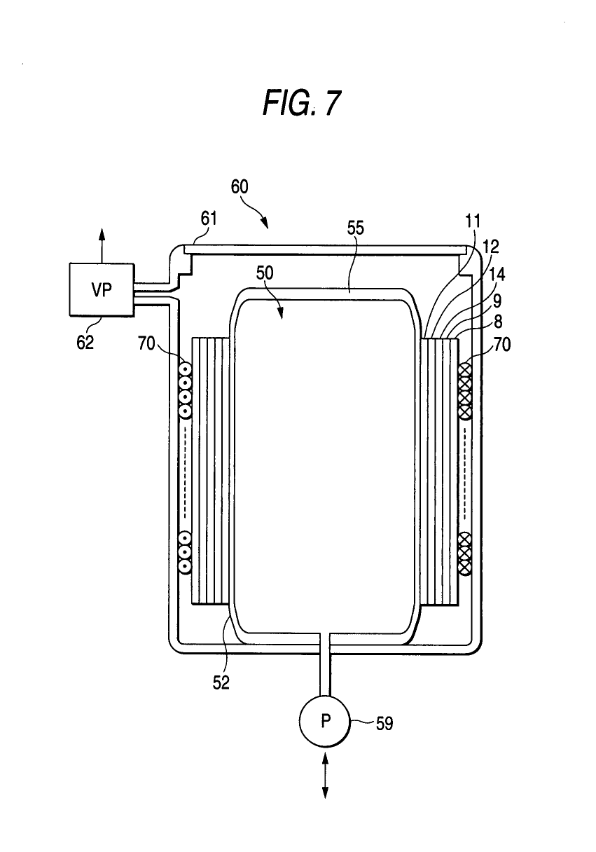

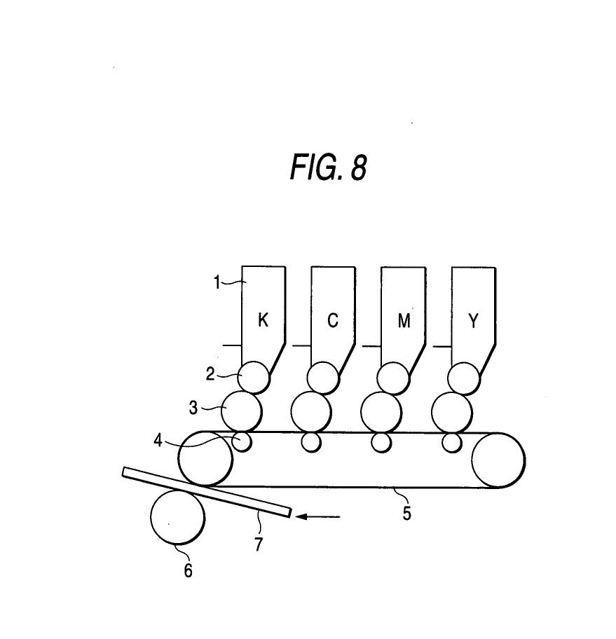

The adhering operation of the first composite member and the second composite member will be explained with reference to FIGS. 6 and 7. Referring to FIG. 6, a numeral 50 indicates an entire water bag, while a solid line 51 indicates a trunk part thereof, and a broken line 52 indicates the trunk part in a state with an increased diameter. 55 indicates end plates at the upper and lower end of the trunk part, and 59 indicates a pump. There are also shown a vacuum chamber 60, a cover 61 thereof, and a vacuum pump 62. Referring to FIG. 7, 70 indicates a detachable electric heater.

The water bag 50 entirely constitutes a liquid container, of which a trunk part 51 is made of silicone rubber. Therefore, the trunk part 51 thereof can be inflated, as shown in FIG. 6, by increasing the pressure of an internal liquid by the pump 59. The trunk part 51 has a thickness of 10 mm in order to realize a self-standing property, but such thickness does not affect at all the inflatable property.

Further, the rubber is made somewhat thinner in a central part thereof, in order that gas can satisfactorily escape from the center of the adhered surface toward the lateral sides thereof.

The vacuum chamber 60 is a container, in which the water bag 50, with the half-finished resinous belt wound on the external periphery thereof, can be accommodated or from which it can be taken out, in a state connected with the external pump 59. For this purpose, the chamber is provided, in an upper part thereof, with an open-closable cover 61, and the interior is connected to a vacuum pump 62.

In practice, these parts have somewhat more complex structures, for example a complex sealing structure employed in the connection of the trunk part 51 of the water bag 50 and the end plates 55, but these structures are not illustrated as they are not much related to the gist of the invention.

Now the mode of adhering operation will be explained with reference to FIG. 7.

FIG. 7 shows a state where the water bag 50, on which the second composite member formed by the base layer 11 and the elastic layer 12 in a half-finished state is fitted, is inserted into the external tube 8 in which the first composite member formed by the binder layer 14 and the surface layer 9 in a half-finished state is fixed on the internal surface, then the water bag is installed in the vacuum chamber 60 and the pressure of the internal fluid is elevated.

Therefore, the half-finished resinous belt formed by four resin layers is pressed to the internal surface of the external tube 8, by the trunk part 52 inflated by the internal pressure of the water bag 50.

In this operation, the external tube 8, being made of stainless steel, is not deformed at all. On the other hand, the trunk part 51 or 52 of the water bag 50, being made of silicone rubber film, uniformly presses the resin layers to the internal surface of the external tube 8, regardless whether the end plates 55 on both ends are present or absent, by elevating the internal fluid pressure of the water bag 50 to 100 atm.

At this operation, the internal air of the vacuum chamber 60 is discharged by the vacuum pump 62, whereby the interior of the vacuum chamber 60 is made vacuum.

In this state, the 4-layered endless resin is heated by maintaining the interior of the vacuum chamber 60 at 120° C. During this heating, the inflated trunk part 52 of the water bag 50 uniformly pressed the external tube 8 from the internal surface side thereof, thereby obtaining a 4-layered resinous belt in which the second composite member constituted of the base layer 11 and the intermediate layer 12 and the first composite member constituted of the binder layer 14 and the surface layer 9 are firmly adhered.

Then the interior of the vacuum chamber 60 is returned to the atmospheric pressure, also the temperature is lowered to the room temperature, then the internal fluid pressure of the water bag 50 is lowered, and the external tube 8 bearing the 4-layered resin layers on the internal surface thereof is taken out of the vacuum chamber 60. Thereafter the 4-layered resinous belt is detached from the external tube 8 to obtain a transfer belt for image forming apparatus.

The transfer belt for image forming apparatus thus obtained included, on the base layer (polyimide) of a thickness of 60 μm, an intermediate layer (urethane) of a thickness of 200 μm, a binder layer (THV) of a thickness of 1 μm, and a surface layer (PTFE) of a thickness of 5 μm, and there could be obtained a transfer belt for image forming apparatus excellent in the surface resistivity, the toner releasing property and the non-contaminating property.

Further, the intermediate layer and the binder layer showed a satisfactory adhesive property.

1. A producing method for a transfer belt for image forming apparatus, comprising:
a first composite member forming step of forming a surface layer formed by polytetrafluoroethylene (PTFE) or tetrafluoroethylene perfluoroalkylvinyl ether (PFA), and then forming a binder layer on the surface layer to form a first composite member;
a second composite member forming step of forming an elastic layer constituted of an elastomer on a base layer constituted of at least a material selected from a class of polyimide (PI), polyamidimide (PAI) and polyvinylidene fluoride (PVDF) to form a second composite member; and
a composite member fusing step of heat fusing the binder layer of the first composite member and the elastic layer of the second composite member, wherein
the binder layer is formed by a material of which a melting point is equal to or lower than a thermal decomposition point of a material constituting the elastic layer, and of which a thermal decomposition point is equal to or higher than a melting point of a material constituting the surface layer.

2. The producing method for a transfer belt for image forming apparatus according to claim 1, wherein
the internal surface of the external tube is mirror finished.

3. The producing method for a transfer belt for image forming apparatus according to claim 1, wherein
the step of forming the second composite member comprises:
a step of forming the base layer on a cylindrical mold;
a step of forming the elastic layer on the base layer; and
a step of separating a composite member constituted of the base layer and the elastic layer from the cylindrical mold to form a cylindrical second composite member.

4. The producing method for a transfer belt for image forming apparatus according to claim 1, wherein
the composite member fusing step comprises:
a first internal core insertion step of inserting an internal core, having a thermal expansion coefficient larger than a thermal expansion coefficient of the external tube, into the interior of the cylindrically formed second composite member;
a second internal core insertion step of inserting the internal core, inserted inside the second composite member, into the external tube; and
a composite member heat fusing step of heating the external tube and the internal core to heat fuse the binder layer of the first composite member and the elastic layer of the second composite member.

5. The producing method for a transfer belt for image forming apparatus according to claim 4, wherein
the internal core is formed by MC nylon or a fluorinated resin.

6. The producing method for a transfer belt for image forming apparatus according to claim 1, wherein
the composite member fusing step comprises:
a water bag insertion step of fitting the second composite member on an external periphery of a water bag closed on both ends and having a hollow cylindrical shape, of which a radius is capable to be increased or decreased by regulating a pressure of a fluid filled therein, and inserting the water bag in such a state inside the first composite member fixed on the internal surface of the external tube;
an evacuating step, after the water bag insertion step, of maintaining the exterior of the water bag in vacuum state;
a pressurizing step, after the water bag insertion step, of increasing a pressure of the fluid filled in the water bag to increase a diameter of the water bag to cause the external periphery of the second composite member, present on the external periphery of the water bag, to pressurize onto an internal periphery of the first composite member; and
an adhesion step, after the evacuating step and the pressurizing step, of heating the interior of the vacuum chamber to adhere the external periphery of the second composite member and the internal periphery of the first composite member.

7. The producing method for a transfer belt for image forming apparatus according to claim 6, wherein
the water bag utilizes silicone rubber in an external peripheral surface thereof.

8. The producing method for a transfer belt for image forming apparatus according to claim 1, wherein
the material constituting the binder layer is a material soluble in a solvent.

9. The producing method for a transfer belt for image forming apparatus according to claim 1, wherein
the binder layer is constituted of a copolymer (THV) of tetrafluoroethylene, hexafluoropropylene and vinylidene fluoride.

10. The producing method for a transfer belt for image forming apparatus according to claim 1, wherein
the binder layer contains a fluorine-containing polymer which constitutes the surface layer.

11. The producing method for a transfer belt for image forming apparatus according to claim 1, wherein
the elastomer is an urethane.

12. A transfer belt for image forming apparatus produced by the producing method according to claim 1.

13. A producing apparatus for use in the producing method for the transfer belt for image forming apparatus according to claim 1, comprising:
a water bag having a hollow cylindrical shape, which is capable to be inserted, in a state where the second composite member is fitted on an external periphery thereof, inside the first composite member fixed on the internal surface of the external tube, and of which a radius is capable to be increased or decreased by regulating a pressure of a fluid filled therein;
a pressure regulating pump for regulating the pressure of the fluid filled in the water bag;
a vacuum chamber in which the water bag is capable to be provided in a state communicating with the pressure regulating pump; and
a heater for heating the interior of the vacuum chamber.

14. The producing apparatus for a transfer belt for image forming apparatus according to claim 13, wherein
the water bag utilizes silicone rubber in an external peripheral surface thereof.

15. A producing apparatus for use in the producing method for the transfer belt for image forming apparatus according to claim 6, comprising:
a water bag having a hollow cylindrical shape, which is capable to be inserted, in a state where the second composite member is fitted on an external periphery thereof, inside the first composite member fixed on the internal surface of the external tube, and of which a radius is capable to be increased or decreased by regulating a pressure of a fluid filled therein;
a pressure regulating pump for regulating the pressure of the fluid filled in the water bag;
a vacuum chamber in which the water bag is capable to be provided in a state communicating with the pressure regulating pump; and
a heater for heating the interior of the vacuum chamber.

16. The producing apparatus for a transfer belt for image forming apparatus according to claim 15, wherein
the water bag utilizes silicone rubber in an external peripheral surface thereof.
